(19) United States
(12) Patent Application Publication
(10) Pub. No.: US 2014/0043617 A1
(43) Pub. Date: Feb. 13, 2014

(54) MEASUREMENT APPARATUS AND MEASUREMENT METHOD

(71) Applicant: CANON KABUSIKI KAISHA, Tokyo (JP)

(72) Inventor: Takanori Uemura, Saitama-shi (JP)

(73) Assignee: CANON KABUSHIKI KAISHA, Tokyo (JP)

(21) Appl. No.: 14/057,476

(22) Filed: Oct. 18, 2013

(30) Foreign Application Priority Data
May 11, 2012 (JP) 2012-243851

(51) Int. Cl. G01B 9/02

(52) U.S. Cl. CPC G01B 9/02041
USPC 356/495

(57) ABSTRACT

The present invention provides a measurement apparatus which measures a shape of a test object, including a detection unit configured to detect interference light between reference light from a reference surface and test light from the test object, thereby obtaining an interference image, and a processing unit configured to perform processing of obtaining the shape of the test object based on the interference image obtained by the detection unit, wherein in a measurement mode in which the interference image is obtained under a measurement condition that the optical path length difference measurable range is a second range smaller than a first range, the processing unit obtains a second shape of the test object by using data of an obtained first shape, and the interference image obtained by the detection unit in the measurement mode.

### BACKGROUND OF THE INVENTION

1. Field of the Invention

The present invention relates to a measurement apparatus and measurement method for measuring the shape of a test object.

2. Description of the Related Art

There is known a measurement apparatus which measures the shape of a test object by using the principle of an interferometer. A measurement apparatus of this type adopts a light source (variable frequency light source) which outputs coherent light and changes the frequency of the light.

In the measurement apparatus, light from the light source is branched, and the respective beams are guided to a reference surface and test object. The beams respectively reflected by the reference surface and test object are spatially merged again, forming interference light having a phase corresponding to the optical path length difference between the reference surface and the test object. The intensity of the interference light is then detected. At this time, the frequency of light from the light source is temporally scanned (changed) at a predetermined interval. At the respective frequencies, light intensities of interference light are detected. Fourier transform and peak detection are performed based on the light intensities of interference light, calculating the optical path length difference between the reference surface and the test object.

In the measurement apparatus, the minimum interval of the scan step when scanning the frequency of light from the light source is restricted by the specifications of the light source. If the interval of the scan step is excessively small with respect to the scan range of the frequency of light, the measurement time becomes long because many light intensities (interference images) of interference light need to be detected.

To solve this, U.S. Pat. No. 7,986,414 proposes a technique of determining the order of interference by using known shape information (for example, design information (CAD data)) representing the shape of a test object when the test object is larger than a measurable range where the order of interference does not become uncertain and the shape can be measured. When the frequency of interference light is 0 or close to the Nyquist frequency, the measurement error becomes large. Considering this, in the technique disclosed in U.S. Pat. No. 7,986,414, a range where the measurement error becomes large is set as an exclusion region. Information about the exclusion region is calculated from the interval of the scan step of the frequency of light from the light source. A test object is arranged so that the measurement point does not fall in the exclusion region.

However, every time the type of test object is changed, the conventional measurement apparatus requires input (setting) of known shape information (CAD data) and spends time and effort for this. Especially when the shapes of many types of test objects in small amounts are measured, it is greatly cumbersome to input CAD data for every test object. For example, at the manufacturing site of a factory where the shape of a test object is measured (inspected), it is often the case that there are only drawings representing the shape of a test object and there is no CAD data. In such a case, if the test object needs to be inspected urgently, CAD data may not be obtained quickly, and inspection of the test object is retarded. Further, handling of CAD data, that is, the operation of CAD software is complicated, and time is taken for proficiency.

### SUMMARY OF THE INVENTION

The present invention provides a technique advantageous for easily measuring the shape of a test object in a short time.

According to one aspect of the present invention, there is provided a measurement apparatus which measures a shape of a test object, including a detection unit configured to detect interference light between reference light from a reference surface and test light from the test object, thereby obtaining an interference image, and a processing unit configured to perform processing of obtaining the shape of the test object based on the interference image obtained by the detection unit, wherein in a first measurement mode in which the interference image is obtained under a measurement condition that an optical path length difference measurable range where an optical path length difference does not become uncertain and can be measured is a first range, the processing unit obtains a first shape of the test object based on the interference image obtained by the detection unit in the first measurement mode, and in a second measurement mode in which the interference image is obtained under a measurement condition that the optical path length difference measurable range is a second range smaller than the first range, the processing unit obtains a second shape of the test object by using data of the obtained first shape, and the interference image obtained by the detection unit in the second measurement mode.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus in the first embodiment of the present invention.

FIG. 2 is a view showing the arrangement (monitor) of part of the selection unit of the measurement apparatus shown in FIG. 1.

FIG. 3 is a flowchart for explaining processing (operation) in a registration mode in the measurement apparatus shown in FIG. 1.

FIG. 4 is a view showing a display example of the shape of a test object that is calculated in step S306 shown in FIG. 3.

FIG. 5 is a flowchart for explaining processing (operation) in an actual measurement mode in a measurement apparatus shown in FIG. 1.

FIG. 6 is a schematic view showing the arrangement of a measurement apparatus in the second embodiment of the present invention.

FIG. 7 is a flowchart for explaining in detail processing of obtaining a plurality of interference images in the registration mode in the measurement apparatus shown in FIG. 6.

FIG. 8 is a graph showing a temporal change of the frequency of light from each of a variable frequency light source and fixed frequency light sources in the measurement apparatus shown in FIG. 6.

FIG. 9 is a flowchart for explaining in detail processing of obtaining a plurality of interference images in the actual measurement mode in the measurement apparatus shown in FIG. 6.

FIG. 10 is a graph showing a temporal change of the frequency of light from each of the variable frequency light source and fixed frequency light sources in the measurement apparatus shown in FIG. 6.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

FIG. 1 is a schematic view showing the arrangement of a measurement apparatus 10 in the first embodiment of the present invention. The measurement apparatus 10 is a three-dimensional measurement apparatus which measures the shape of a test object.

The measurement apparatus 10 includes a light source 101, a mirror 102, a beam splitter 103, a frequency measurement unit 104, lenses 105 and 106, and an interference optical system 120. The measurement apparatus 10 also includes a selection unit 130, detection unit 140, processing unit 150, digital/analog converter 160, and storage unit 180.

The light source 101 is a variable frequency light source which outputs coherent light and changes the frequency of the light (that is, the frequency can be scanned in a predetermined range). As the light source 101, for example, a semiconductor laser (ECDL) using an external resonator, or a full-band tunable DFB (Distributed Feed-Back) laser is usable. The light source 101 is connected to the digital/analog converter 160. The frequency of light to be emitted by the light source 101 is scanned (changed) by controlling a current (current value) to be supplied from the digital/analog converter 160 to the light source 101.

Light from the light source 101 is guided via the mirror 102 to the beam splitter 103 which branches (splits) light from the light source 101 into two beams. One beam branched by the beam splitter 103 is guided to the frequency measurement unit 104. The frequency measurement unit 104 measures the frequency of light emitted by the light source 101, and inputs the measurement result to the processing unit 150. When the frequency of light emitted by the light source 101 can be guaranteed at high accuracy (that is, the frequency of light emitted by the light source 101 need not be measured), the frequency measurement unit 104 may be omitted.

The other beam branched by the beam splitter 103 is guided to the interference optical system 120 via the lenses 105 and 106 which increase the beam diameter. The interference optical system 120 includes a λ/2 plate 107, a polarizing beam splitter 108, λ/4 plates 109a and 109b, a reference mirror 110, and a lens 113. Further, the interference optical system 120 includes a stop 114, a lens 115, a polarizer 116, a test stage 117, and incoherent light sources 118.

The λ/2 plate 107 is held to be rotatable. Since light emitted by the light source 101 is linearly polarized light, the direction of polarization of light having passed through the λ/2 plate 107 can be controlled (adjusted) in an arbitrary direction based on the rotation angle of the λ/2 plate 107. The polarizing beam splitter 108 is arranged at the output stage of the λ/2 plate 107. The branching ratio of light in the polarizing beam splitter 108 can be changed in accordance with the rotation angle of the λ/2 plate 107.

The polarizing beam splitter 108 branches (splits) light from the light source 101 into reference light 121 and test light 122 having directions of polarization perpendicular to each other. The reference light 121 passes through the λ/4 plate 109a and enters the reference mirror (reference surface) 110. The test light 122 passes through the λ/4 plate 109b and enters a test object 170. The test object 170 is held on the test stage 117.

The test light 122 reflected (or scattered) by the test object 170 passes again through the λ/4 plate 109b and enters the polarizing beam splitter 108. Similarly, the reference light 121 reflected by the reference mirror 110 passes again through the λ/4 plate 109a and enters the polarizing beam splitter 108. Each of the reference light 121 and test light 122 passes twice through the λ/4 plate to rotate the direction of polarization by 90°. The reference light 121 is reflected by the polarizing beam splitter 108, the test light 122 passes through the polarizing beam splitter 108, and the reference light 121 and test light 122 are spatially merged.

The lens 113 converges the reference light 121 and test light 122 merged by the polarizing beam splitter 108. The lens 113 is arranged to position the front focus near the test object 170. With this setting, the image of (the shape of) the test object 170 is formed on (the detection surface of) the detection unit 140 without a blur.

The stop 114 is arranged near the rear focus of the lens 113. The stop 114 may be an aperture stop whose aperture diameter is fixed, or an iris stop whose aperture diameter is variable. When the iris stop is used as the stop 114, the light amount, depth of field, speckle size, and the like can be adjusted by the aperture diameter.

The reference light 121 and test light 122 having passed through the stop 114 are converged by the lens 115 and guided to the polarizer 116. The polarizer 116 is arranged to have a transmission axis inclined by 45° with respect to the direction of polarization of the reference light 121 and test light 122. With this setting, the reference light 121 and test light 122 interfere with each other, forming interference light 123.

The interference light 123 is guided to the detection unit 140. The detection unit 140 is formed from, for example, an area sensor such as a CCD sensor or CMOS sensor. The detection unit 140 detects the light intensity of the interference light 123 and inputs the detection result (interference image) to the processing unit 150.

When the surface roughness of the test object 170 is large, if the test object 170 is irradiated with coherent light from the light source 101, a speckle is generated and the detection unit 140 cannot obtain a clear interference image. This makes it difficult to measure the dimensions of the test object 170 in a direction (lateral direction) perpendicular to the optical axis at high accuracy.

The embodiment adopts the incoherent light source 118 which outputs incoherent light. The lateral dimension of the test object 170 is calculated by using an image obtained by irradiating the test object 170 with incoherent light from the incoherent light source 118. The longitudinal (optical axis direction) dimension of the test object 170 is calculated by using an interference image obtained by irradiating the test object 170 with coherent light from the light source 101.

In the embodiment, the test object 170 is irradiated with light from the incoherent light source 118, and the detection unit 140 detects the light reflected by the test object 170. However, the present invention is not limited to this arrangement. For example, it is also possible to form the test stage 117 from a transparent material such as glass, illuminate the test object 170 from behind the test stage 117, and detect, by the detection unit 140, a shadow casted by the test object 170.

The processing unit 150 includes a CPU and memory, and controls the overall (operation of) measurement apparatus 10. The processing unit 150 performs processing of obtaining the shape of the test object 170 by controlling the respective units of the measurement apparatus 10.

The storage unit 180 stores shape data representing the shape of the test object 170 that is calculated based on an interference image obtained by the detection unit 140, that is, shape data representing the shape of the test object 170 that is obtained by the processing unit 150.

A principle when obtaining the shape of the test object 170 will be explained. Letting ΔF be the scan range of the frequency of light emitted by the light source 101, c be the speed of light, and ΔΦ be the phase change amount of interference light, the optical path length difference between the reference mirror 110 and the test object 170 is given by equation (1):

$$L = \frac{c ΔΦ}{4 πΔ F} \qquad ( 1 )$$

The frequency scanning interferometer, that is, the measurement apparatus 10 can calculate the optical path length difference between the reference mirror 110 and the test object 170 by obtaining the phase change amount of interference light when the frequency of light from the light source 101 is scanned. The calculation accuracy of the optical path length difference between the reference mirror 110 and the test object 170 is affected by the detection error of the phase change amount of interference light and the scan range of the frequency of light from the light source 101. For example, when the scan range of the frequency of light from the light source 101 is increased, the calculation error of the optical path length difference between the reference mirror 110 and the test object 170 is decreased.

Letting Δf be the interval of the scan step of the frequency of light from the light source 101, a measurable range D where the frequency of interference light does not exceed the Nyquist frequency and the optical path length difference does not become uncertain and can be measured is given by equation (2):

$$D = \frac{c}{4 Δ f} \qquad ( 2 )$$

The measurable range D where the optical path length difference does not become uncertain and can be measured becomes wider as the interval Δf of the scan step of the frequency of light from the light source 101 becomes smaller. Therefore, to widen the measurable range D, it suffices to decrease the interval Δf of the scan step of the frequency. However, decreasing the interval Δf of the scan step of the frequency increases the number of frequency scan steps. Thus, the number of interference images obtained by the detection unit 140 increases, prolonging the measurement time.

To solve this, the embodiment employs the selection unit 130 which selects one measurement mode from measurement modes including a registration mode (first measurement mode) and actual measurement mode (second measurement mode) in accordance with a user input (instruction). The registration mode is a measurement mode in which the shape of the test object 170 is measured and the shape data is registered. In the registration mode, an interference image is obtained under a measurement condition that the measurable range D of the shape of a test object is the first range. The shape of the test object is calculated based on this interference image, and shape data representing the calculated shape of the test object is stored (registered) in the storage unit 180. The actual measurement mode is a measurement mode in which a test object of the same type as that of a test object corresponding to shape data already stored in the storage unit 180 is measured (for example, successively measured). In the actual measurement mode, an interference image is obtained under a measurement condition that the test object shape measurable range D is the second range smaller than the first range. The shape of the test object is obtained based on this interference image, and shape data stored in the storage unit 180. By setting these measurement modes to be selectable, the measurement apparatus 10 can easily measure the shape of the test object 170 in a short time, which will be described later.

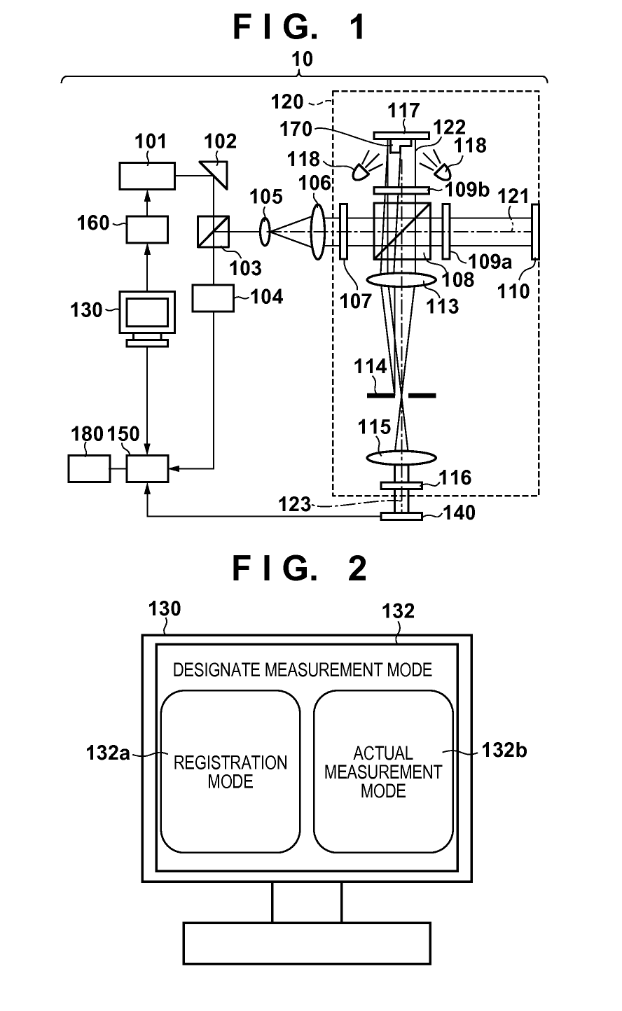

FIG. 2 is a view showing the arrangement of part of the selection unit 130, that is, a monitor 132 functioning as an input unit for inputting a measurement mode by the user (accepting a user instruction). The monitor 132 may be formed from a touch panel, or include an input device such as a keyboard or mouse. The monitor 132 displays an icon 132a for designating the registration mode, and an icon 132b for designating the actual measurement mode. The user can designate a measurement mode via the monitor 132 (that is, by selecting the icon 132a or 132b).

When measuring a test object of a type which has not been measured by the measurement apparatus 10, the selection unit 130 selects the registration mode as the measurement mode in accordance with a user input or automatically. In the registration mode, the measurement condition is set so that a scan range ΔF₁ of the frequency of light from the light source 101 becomes 3 THz and the interval Δf₁ of the scan step becomes 1.5 GHz. In this case, assuming that the phase detection error of interference light is 2π/100, the calculation accuracy of the optical path length difference becomes 0.5 μm. The measurable range D where the optical path length difference does not become uncertain and can be measured becomes 50 mm. Hence, the number of interference images obtained by the detection unit 140 becomes 2,000. Assuming that the image sensing rate of an interference image obtained by the detection unit 140 is 60 fps, 33.3 sec is necessary as the time taken to obtain an interference image.

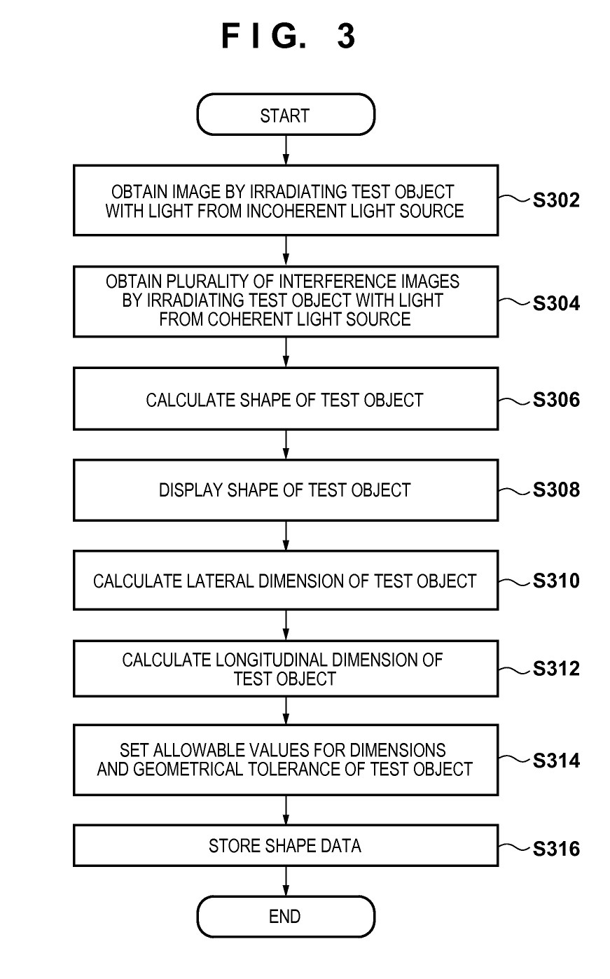

FIG. 3 is a flowchart for explaining processing (operation) in the registration mode in the measurement apparatus 10. The processing in the registration mode is performed by comprehensively controlling the respective units of the measurement apparatus 10 by the processing unit 150.

In step S302, the test object 170 is irradiated with light (incoherent light) from the incoherent light source 118. The detection unit 140 detects the light reflected by the test object 170, obtaining an image.

In step S304, the test object 170 is irradiated with light (coherent light) from the light source 101 while the frequency is scanned. The detection unit 140 detects the interference light beams 123 of the respective frequencies, obtaining a plurality of interference images.

In step S306, the shape (three-dimensional shape) of the test object 170 is calculated by performing Fourier transform and peak detection based on the image obtained in step S302 and the plurality of interference images obtained in step S304.

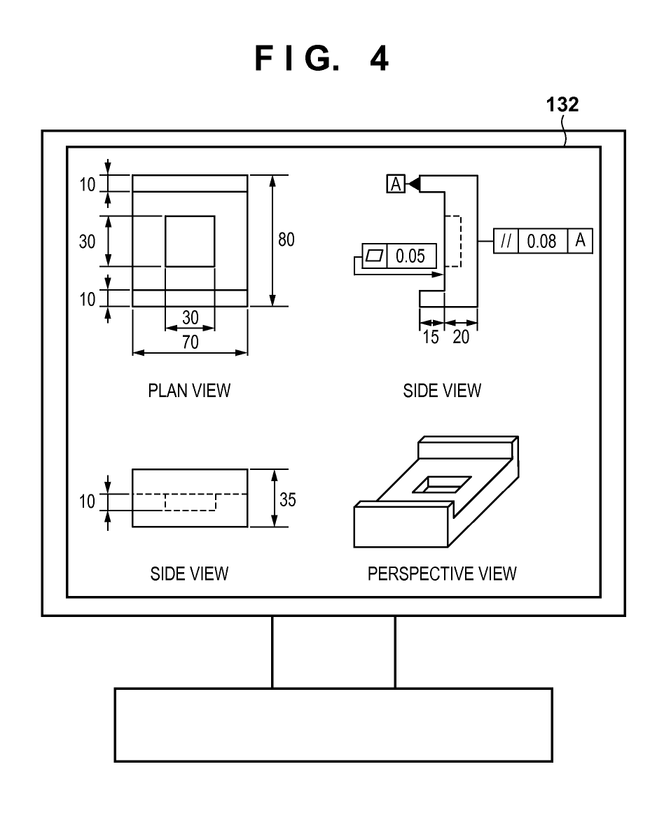

In step S308, for example, the monitor 132 of the selection unit 130 displays the shape of the test object 170 that has been calculated in step S306. FIG. 4 is a view showing a display example of the shape of the test object 170 that has been calculated in step S306. As shown in FIG. 4, the monitor 132 displays the plan, side, and perspective views of the test object 170 as the shape of the test object 170. The user can input the measurement target region (portion to be measured in the actual measurement mode) of the test object 170, the tolerance, and the like via the monitor 132 (that is, for the test object 170 displayed on the monitor 132).

In step S310, the lateral dimension of the test object 170 is calculated. In the plan view of FIG. 4, an image obtained by irradiating the test object 170 with incoherent light from the incoherent light source 118 is displayed. By using this image, the lateral dimension of the test object 170 is calculated. At this time, the user can designate a portion where he wants to calculate the lateral dimension of the test object 170. The processing unit 150 calculates the dimension by performing image processing such as edge detection for the portion designated by the user. In edge detection, sub-pixel processing can be performed to detect an edge at an accuracy of 1/10 or less of pixels forming the detection surface of the detection unit 140.

In step S312, the longitudinal dimension of the test object 170 is calculated. In the side and perspective views of FIG. 4, the shape of the test object 170 obtained from a plurality of interference images obtained by irradiating the test object 170 with coherent light from the light source 101 is displayed. From the shape of the test object 170, the longitudinal dimension is calculated. At this time, the user can designate a portion where he wants to calculate the longitudinal dimension of the test object 170. In measurement using the interferometer, light enters the upper surface of the test object 170 perpendicularly, so the side surface of the test object 170 cannot be measured. However, the absence of the side surface of the test object 170 is unnatural when displaying the shape of the test object 170. Thus, processing of automatically obtaining the side surface of the test object 170 is performed in the embodiment. The maximum height of the test object 170 shown in FIG. 4 is 35 mm, which is smaller than the 50-mm measurable range D. Hence, the height of the test object 170 does not become uncertain and can be measured.

As for the side and perspective views of the test object 170, the edge is detected by image processing, similar to the plan view of the test object 170. Since the plan view of the test object 170 is two-dimensional data, a calculable dimension is limited to the distance between lines or the like. However, the side and perspective views of the test object 170 are obtained from three-dimensional data, so the distance between planes or the like can also be calculated. When the user designates a plane of the test object 170, a geometrical tolerance such as the flatness or parallelism of this plane can also be calculated.

In step S314, allowable values are set for the dimensions and geometrical tolerance of the test object 170 in accordance with a user input. By setting allowable values for the dimensions and geometrical tolerance of the test object 170, whether the shape of the test object 170 satisfies specifications can be determined when the shape of a test object 170 of the same type is measured in the actual measurement mode.

In step S316, shape data representing the shape of the test object 170 that has been calculated in step S306 is stored (registered) in the storage unit 180. At this time, the shape data is stored in association with the type of the test object 170. The shape data representing the shape of the test object 170 may be shape data representing the overall shape of the test object 170, or shape data representing the shape of only a characteristic portion of the test object 170. The shape data stored in the storage unit 180 is used for pattern matching to be performed in the actual measurement mode.

When measuring a test object of a type which has been measured by the measurement apparatus 10 (when shape data representing the shape of a test object of the same type has been stored in the storage unit 180), the selection unit 130 selects the actual measurement mode as the measurement mode in accordance with a user input or automatically. In the actual measurement mode, the measurement condition is set so that a scan range ΔF₂ of the frequency of light from the light source 101 becomes 3 THz and the interval Δf₂ of the scan step becomes 5 GHz. In this case, assuming that the phase detection error of interference light is 2π/100, the calculation accuracy of the optical path length difference becomes 0.5 μm. The measurable range D where the optical path length difference does not become uncertain and can be measured becomes 15 mm. Hence, the number of interference images obtained by the detection unit 140 becomes 600. Assuming that the image sensing rate of an interference image obtained by the detection unit 140 is 60 fps, 10 sec is necessary as the time taken to obtain an interference image. In the actual measurement mode, the number of interference images obtained by the detection unit 140 is smaller than that in the registration mode, so the shape of the test object 170 can be measured in a ⅓ or less time (that is, in a short time).

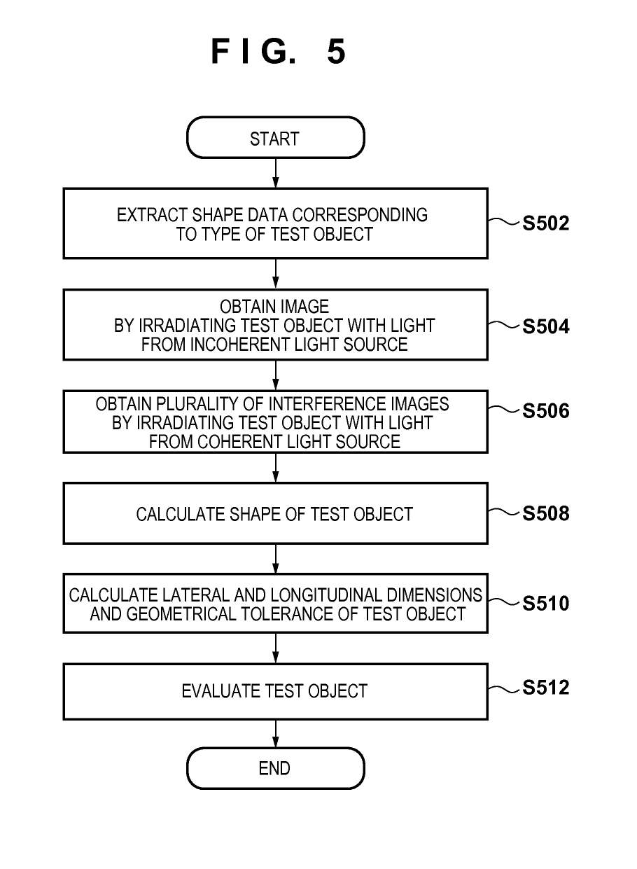

FIG. 5 is a flowchart for explaining processing (operation) in the actual measurement mode in the measurement apparatus 10. The processing in the actual measurement mode is performed by comprehensively controlling the respective units of the measurement apparatus 10 by the processing unit 150.

In step S502, shape data corresponding to the type of the test object 170 to be measured in the actual measurement mode is extracted from the storage unit 180. The shape data is extracted in accordance with a user input or automatically by reading an identifier for identifying the type of the test object 170.

In step S504, the test object 170 is irradiated with light (incoherent light) from the incoherent light source 118. The detection unit 140 detects the light reflected by the test object 170, obtaining an image.

In step S506, the test object 170 is irradiated with light (coherent light) from the light source 101 while the frequency is scanned. The detection unit 140 detects the interference light beams 123 of the respective frequencies, obtaining a plurality of interference images.

In step S508, the shape (three-dimensional shape) of the test object 170 is calculated by using the shape data extracted in step S502, the image obtained in step S504, and the plurality of interference images obtained in step S506.

More specifically, first, pattern matching is performed between the shape data extracted in step S502, and the shape of the test object 170 that is obtained from the plurality of interference images obtained in step S506. By this pattern matching, the orientation of the test object 170 held on the test stage 117 is finalized. After the orientation of the test object 170 is finalized, the dimensions and tolerance of the measurement target region of the test object 170 designated in the registration mode are automatically calculated in the actual measurement mode without designating the measurement target region and tolerance of the test object 170. In the actual measurement mode, the dimensions and geometrical tolerance of the test object 170 can be obtained easily.

When the height of the test object 170 is larger than the measurable range D, it becomes uncertain. In this case, the frequency of the interference light 123 exceeds the Nyquist frequency at a portion where the optical path length difference between the test object 170 and the reference mirror 110 is large. If the frequency of the interference light 123 exceeds the Nyquist frequency, a phenomenon called aliasing occurs, and the frequency of the interference light 123 is obtained as an aliased value with respect to the Nyquist frequency. Assuming that a distance corresponding to the Nyquist frequency is 15 mm, interference light corresponding to an optical path length difference of 14 mm and interference light corresponding to an optical path length difference of 16 mm cannot be discriminated.

In the embodiment, to eliminate this uncertainty, shape data (shape data representing the shape of the test object 170 that has been measured in the registration mode) stored in the storage unit 180 in the registration mode is used. When an actual optical path length difference is 16 mm, which of 14 mm or 16 mm is an optical path length difference cannot be determined by only analyzing an interference image. However, by collation with shape data stored in the storage unit 180, the optical path length difference can be determined. For example, if shape data stored in the storage unit 180 represents 16+0.1 mm as the height of the test object 170, the optical path length difference can be determined to be 16 mm.

In step S510, the lateral and longitudinal dimensions and geometrical tolerance of a portion of the test object 170 that has been designated in the registration mode are calculated based on the shape of the test object 170 that has been calculated in step S508.

In step S512, the test object 170 is evaluated based on the dimensions and geometrical tolerance calculated in step S510. More specifically, it is determined whether the shape of the test object 170 satisfies specifications.

When the frequency of the interference light 123 is close to 0, the number of interference fringes is small, and it is difficult to accurately obtain the frequency of the interference light 123. When the frequency of the interference light 123 is close to the Nyquist frequency, the uncertainty becomes smaller than the tolerance of the test object 170, and it becomes difficult to determine the shape of the test object 170. For example, when the tolerance of the dimension of a given portion of the test object 170 is ±0.5 mm, it is difficult to determine which of 14.9 mm and 15.1 mm is an actual optical path length difference. For this reason, it is necessary to prevent the frequency of the interference light 123 from becoming close to 0 or the Nyquist frequency. In the embodiment, the interval (scan interval) of the scan step of the frequency of light from the light source 101 is set by using shape data stored in the storage unit 180 so as to exclude a region where the frequency of the interference light 123 becomes 0 or the Nyquist frequency. Alternatively, the optical path length difference may be changed by moving the test stage 117 holding the test object 170.

The actual measurement mode is selected when shape data corresponding to the type of the test object 170 to be measured has been stored in the storage unit 180. When the test object 170 is a mass-produced component, it is often necessary to measure (inspect) many test objects 170 of the same type. In the actual measurement mode, the shape of the test object 170 can be easily measured in a short time by using shape data stored in the storage unit 180. As the number of test objects 170 is larger, the effect of shortening the time taken to measure the shape of the test object 170 is enhanced much more.

Considering a case in which the shapes of many types of test objects 170 in small amounts are measured (inspected), CAD data (shape data) needs to be input for every type of the test object 170 in the conventional technique, spending time and effort for this. To the contrary, according to the embodiment, shape data representing the shape of the test object 170 can be stored (registered) by only selecting the registration mode. Thus, the time and effort taken to input CAD data can be omitted. As described above, at the manufacturing site of a factory where the shape of the test object 170 is measured (inspected), it is often the case that there are only drawings representing the shape of the test object 170 and there is no CAD data. In the embodiment, even if there is no CAD data, shape data of the test object 170 can be stored. Even a necessity for urgent measurement (inspection) of the shape of the test object 170 can be coped without retarding measurement of the shape of the test object 170. Further, handling of CAD data, that is, the operation of CAD software is complicated, but no CAD data need be handled in the embodiment.

As described above, in the embodiment, shape data stored in the storage unit 180 in the registration mode is used. In the actual measurement mode, the interval of the scan step of the frequency of light from the light source 101 can be widened, and the measurement time of the shape of the test object 170 is shortened. However, in measurement of the shape of the test object 170, the measurement accuracy is sometimes more important than the measurement time. In this case, the measurement accuracy is increased by widening the scan range of the frequency of light from the light source 101 in the actual measurement mode.

For example, in the actual measurement mode, the measurement condition is set so that the scan range ΔF₂ of the frequency of light from the light source 101 becomes 6 THz and the interval Δf₂ of the scan step becomes 5 GHz. In this case, assuming that the phase detection error of interference light is 2π/100, the calculation accuracy of the optical path length difference becomes 0.25 μm. The measurable range D where the optical path length difference does not become uncertain and can be measured becomes 15 mm. Hence, the number of interference images obtained by the detection unit 140 becomes 1,200. Assuming that the image sensing rate of an interference image obtained by the detection unit 140 is 60 fps, 20 sec is necessary as the time taken to obtain an interference image. In this case, the shape of the test object 170 can be measured in a short time in the actual measurement mode by setting the number of interference images obtained by the detection unit 140 to be smaller than that in the registration mode. In addition, the measurement accuracy can be increased from 0.5 μm to 0.25 μm.

In the actual measurement mode, the positional relationship between the interference optical system 120 and the test object 170 may be adjusted by the test stage 117 so as to improve the contrast of an interference image obtained by the detection unit 140 by using shape data stored in the storage unit 180.

As described above, the measurement apparatus 10 according to the first embodiment can easily measure the shape of the test object 170 in a short time.

### Second Embodiment

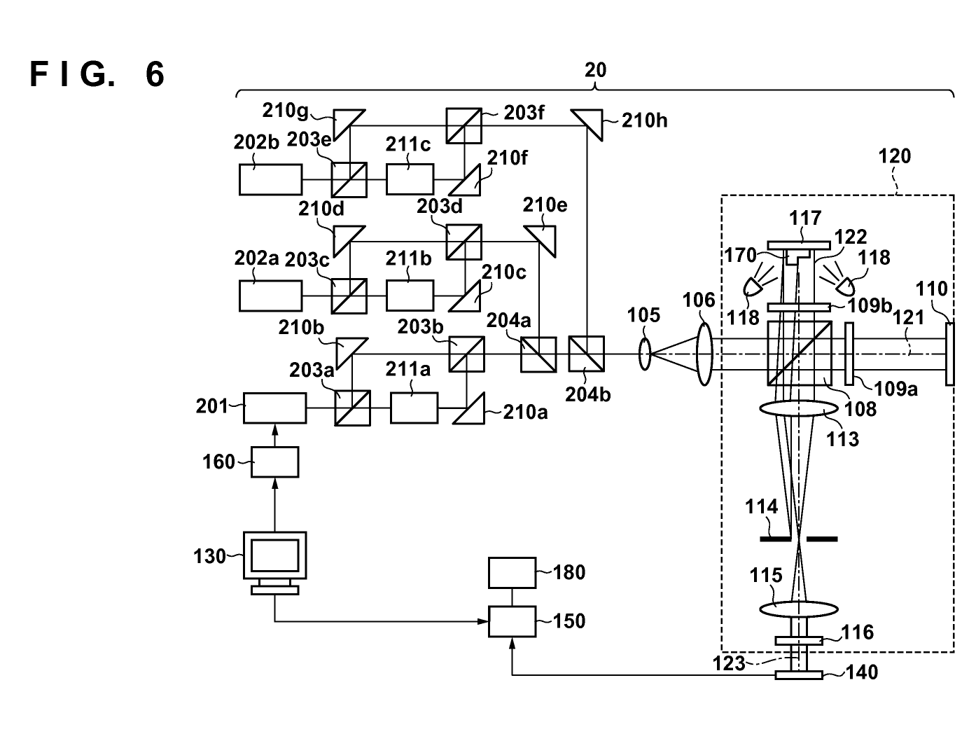

FIG. 6 is a schematic view showing the arrangement of a measurement apparatus 20 in the second embodiment of the present invention. The measurement apparatus 20 is different from the measurement apparatus 10 in the measurement principle when measuring the shape of a test object 170. The measurement apparatus 20 can narrow the scan range ΔF of the frequency of light from a light source, compared to the measurement apparatus 10, as long as the measurement accuracy in the direction of height of the test object 170 is the same as that in the measurement apparatus 10.

The measurement apparatus 20 includes a variable frequency light source 201, fixed frequency light sources 202a and 202b, polarizing beam splitters 203a to 203f, beam coupling elements 204a and 204b, reflecting mirrors 210a to 210h, and frequency shifters 211a to 211c. The measurement apparatus 20 also includes lenses 105 and 106, an interference optical system 120, a selection unit 130, a detection unit 140, a processing unit 150, a digital/analog converter 160, and a storage unit 180.

The variable frequency light source 201 outputs linearly polarized coherent light having a frequency f₁. As the variable frequency light source 201, a DFB laser, VCSEL, discrete mode semiconductor laser, or the like is usable. Also, a semiconductor laser (ECDL) using an external resonator, or a full-band tunable DFB (Distributed Feed-Back) laser is usable.

The light from the variable frequency light source 201 enters the polarizing beam splitter 203a, and is branched (split) into two beams having polarizations perpendicular to each other. One beam branched by the polarizing beam splitter 203a enters the frequency shifter 211a which shifts the frequency by an arbitrary amount. The frequency of this beam is shifted by an arbitrary frequency shift amount df₁. The light from the frequency shifter 211a is reflected by the reflecting mirror 210a, and enters the polarizing beam splitter 203b. The other beam branched by the polarizing beam splitter 203a is reflected by the reflecting mirror 210b, and enters the polarizing beam splitter 203b.

The polarizing beam splitter 203b multiplexes the beam reflected by the reflecting mirror 210a and the beam reflected by the reflecting mirror 210b. The light multiplexed by the polarizing beam splitter 203b will be called the first light. The frequency shift amount df₁ corresponds to the frequency of the beat signal of the first light. To accurately obtain an interference signal (interference image), the frequency of the beat signal needs to be ½ or less of the image sensing rate of the detection unit 140.

The fixed frequency light source 202a emits coherent light having a frequency f₂. The light from the fixed frequency light source 202a enters the polarizing beam splitter 203c, and is branched (split) into two beams. One beam branched by the polarizing beam splitter 203c enters the frequency shifter 211b, and its frequency is shifted by an arbitrary frequency shift amount df₂. The light from the frequency shifter 211b is reflected by the reflecting mirror 210c, and enters the polarizing beam splitter 203d. The other beam branched by the polarizing beam splitter 203c is reflected by the reflecting mirror 210d, and enters the polarizing beam splitter 203d.

The polarizing beam splitter 203d multiplexes the beam reflected by the reflecting mirror 210c and the beam reflected by the reflecting mirror 210d. The light multiplexed by the polarizing beam splitter 203d will be called the second light. The frequency shift amount df₂ corresponds to the frequency of the beat signal of the second light. To accurately obtain an interference signal (interference image), the frequency of the beat signal needs to be ½ or less of the image sensing rate of the detection unit 140.

The second light from the polarizing beam splitter 203d is reflected by the reflecting mirror 210e, and enters the beam coupling element 204a. The beam coupling element 204a may be a beam splitter or wavelength filter.

The fixed frequency light source 202b emits coherent light having a frequency f₃. The light from the fixed frequency light source 202b enters the polarizing beam splitter 203e, and is branched (split) into two beams. One beam branched by the polarizing beam splitter 203e enters the frequency shifter 211c, and its frequency is shifted by an arbitrary frequency shift amount df₃. The light from the frequency shifter 211c is reflected by the reflecting mirror 210f, and enters the polarizing beam splitter 203f. The other beam branched by the polarizing beam splitter 203e is reflected by the reflecting mirror 210g, and enters the polarizing beam splitter 203f.

The polarizing beam splitter 203f multiplexes the beam reflected by the reflecting mirror 210f and the beam reflected by the reflecting mirror 210g. The light multiplexed by the polarizing beam splitter 203f will be called the third light. The frequency shift amount df₃ corresponds to the frequency of the beat signal of the third light. To accurately obtain an interference signal (interference image), the frequency of the beat signal needs to be ½ or less of the image sensing rate of the detection unit 140.

The third light from the polarizing beam splitter 203f is reflected by the reflecting mirror 210h, and enters the beam coupling element 204b. The beam coupling element 204b may be a beam splitter or wavelength filter.

The beam coupling element 204a multiplexes the first light and second light. The beam coupling element 204b multiplexes the light from the beam coupling element 204a and the third light. In this way, the first light, second light, and third light are multiplexed. The multiplexed light is guided to the interference optical system 120 via the lenses 105 and 106 which enlarge the beam diameter. The interference optical system 120 includes a polarizing beam splitter 108, λ/4 plates 109a and 109b, a reference mirror 110, a lens 113, a stop 114, a lens 115, a polarizer 116, a test stage 117, and incoherent light sources 118.

The polarizing beam splitter 108 branches (splits) light from the beam coupling element 204b into reference light 121 and test light 122. The reference light 121 passes through the λ/4 plate 109a and enters the reference mirror (reference surface) 110. The test light 122 passes through the λ/4 plate 109b and enters a test object 170. The test stage 117 arranges the test object 170 to set an optical path length difference L between the reference mirror 110 and the test object 170.

The test light 122 reflected (or scattered) by the test object 170 passes again through the λ/4 plate 109b and enters the polarizing beam splitter 108. Similarly, the reference light 121 reflected by the reference mirror 110 passes again through the λ/4 plate 109a and enters the polarizing beam splitter 108.

The polarizing beam splitter 108 spatially merges the reference light 121 and test light 122, forming interference light 123 via the lens 113, stop 114, lens 115, and polarizer 116. At this time, in the detection unit 140, the interference light 123 in which the three beat signals (first, second, and third beat signals) are superimposed is formed. The first beat signal is a beat signal of light obtained by multiplexing light having the frequency f₁ and light having a frequency f₁+df₁. The second beat signal is a beat signal of light obtained by multiplexing light having the frequency f₂ and light having a frequency f₂+df₂. The third beat signal is a beat signal of light obtained by multiplexing light having the frequency f₃ and light having a frequency f₃+df₃.

In the measurement apparatus 20, similar to the measurement apparatus 10, one measurement mode can be selected from measurement modes including the registration mode and actual measurement mode. Processing in the registration mode and processing in the actual measurement mode in the measurement apparatus 20 are basically the same as those in the measurement apparatus 10. The measurement apparatus 20 is different from the measurement apparatus 10 in processing (steps S304 and S504) of obtaining a plurality of interference images, and processing (steps S306 and S506) of calculating the shape of the test object 170.

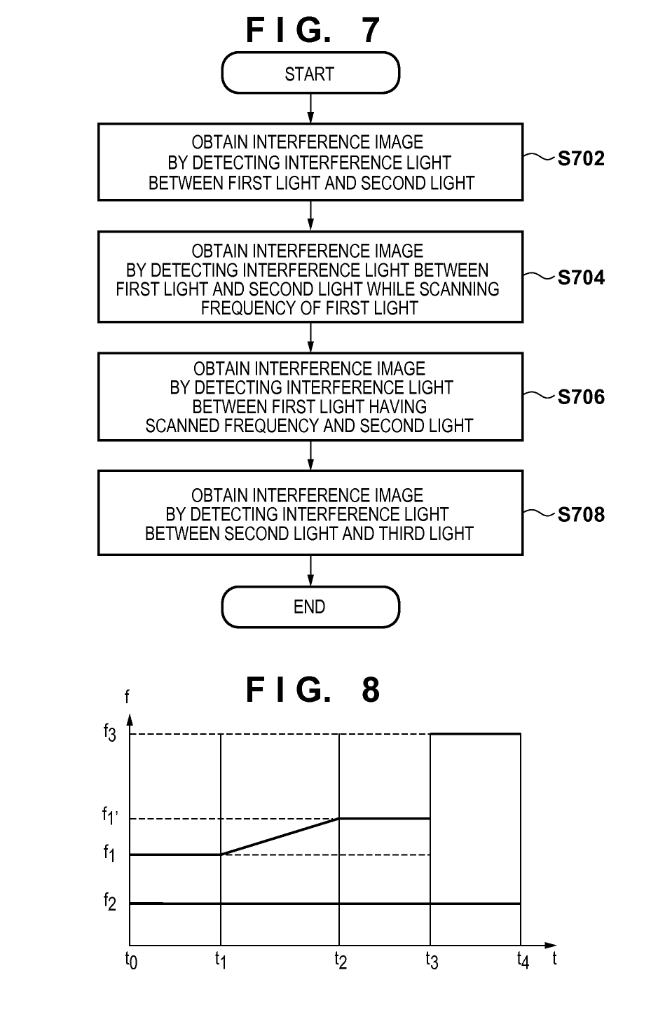

FIG. 7 is a flowchart for explaining in detail processing of obtaining a plurality of interference images in the registration mode, that is, processing corresponding to step S304 in the measurement apparatus 20. In step S702, the detection unit 140 detects interference light between the first light and the second light, obtaining an interference image. More specifically, as shown in FIG. 8, the detection starts from time t₀. The beat signals of the first light and second light are obtained till time t₁ while the frequency shifters 211a and 211b shift the frequencies. FIG. 8 is a graph showing a temporal change of the frequency of light from each of the variable frequency light source 201 and fixed frequency light sources 202a and 202b. In FIG. 8, the ordinate represents the frequency f, and the abscissa represents the time t.

In step S704, while the frequency of the first light is scanned, the detection unit 140 detects interference light between the first light and the second light, obtaining an interference image. More specifically, as shown in FIG. 8, the detection unit 140 obtains a plurality of interference images while the frequency of light emitted by the variable frequency light source 201 is scanned from f₁ to f′₁ at the interval between time t₁ and time t₂.

In step S706, the detection unit 140 detects interference light between the first light having the scanned frequency (first light after the frequency is scanned in step S704) and the second light. More specifically, as shown in FIG. 8, the beat signals of the first light and second light are obtained while the frequency shifters 211a and 211b shift the frequencies at the interval between time t₂ and time t₃.

In step S708, the detection unit 140 detects interference light between the second light and the third light, obtaining an interference image. More specifically, as shown in FIG. 8, the beat signals of the second light and third light are obtained while the frequency shifters 211b and 211c shift the frequencies at the interval between time t₃ and time t₄.

Assuming that the number of interference images obtained in each of the processes in steps S702 to S708 is, for example, 17, a total of 68 interference images are obtained. Assuming that the image sensing rate of an interference image obtained by the detection unit 140 is 60 fps, the time taken to obtain an interference image is 1.1 sec.

The processing unit 150 calculates the shape of the test object 170 based on the interference images obtained in the respective processes of steps S702 to S708. Processing of calculating the shape of the test object 170 in the embodiment will be explained.

First, the first beat signal of light from the variable frequency light source 201 is analyzed. A phase φ₁ is calculated from the first beat signal by performing calculation such as the N bucket method or discrete Fourier transform for the respective pixels of interference images obtained at the interval between time t₀ and time t₁. The numbers of bright points and dark points of interference fringes in the respective pixels are counted from a plurality of interference images obtained at the interval between time t₁ and time t₂. The number of interference fringes which change upon scanning of the frequency is obtained, thereby determining an order M₁ of interference. Further, beat signals are obtained for the respective pixels of interference images obtained at the interval between time t₂ and time t₃, calculation such as discrete Fourier transform is performed, and a phase φ₁, of the beat signal is calculated.

From the phases φ₁ and φ_{1′} and the order M₁ of interference, an optical path length difference H₁ is calculated according to equation (3):

$${H}_{1} = \frac{{Λ}_{{11}^{′}}}{2} ( \frac{{φ}_{{1}^{′}} - {φ}_{1}}{2 π} ) \qquad ( 3 )$$

where Λ_{11′} is the synthetic wavelength given by equation (4):

$${Λ}_{{11}^{′}} = \frac{c}{\vert {f}_{1} - {f}_{1}^{′} \vert} \qquad ( 4 )$$

where c is the speed of light. When the scan range ΔF of the frequency of light from the variable frequency light source 201 is 10 GHz, the synthetic wavelength Λ_{11′} becomes 30 mm.

Then, the second beat signal of light from the fixed frequency light source 202a is analyzed. A phase φ₂ is calculated from the second beat signal by performing calculation such as the N bucket method or discrete Fourier transform for the respective pixels of interference images obtained at the interval between time t₀ and time t₃.

From the phases φ_{1′} and φ₂, an optical path length difference H₂ of each pixel is calculated according to equation (5):

$${H}_{2} = \frac{{Λ}_{{1}^{′} 2}}{2} ( {M}_{2} + \frac{{φ}_{{1}^{′}} - {φ}_{2}}{2 π} ) \qquad ( 5 )$$

where Λ_{1′2} is the synthetic wavelength given by equation (6), and M₂ is the order of interference given by equation (7):

$$\begin{matrix}{Λ}_{{1}^{′} 2} = \frac{c}{\vert {f}_{1}^{′} - {f}_{2} \vert} & ( 6 ) \\ {M}_{2} = round ( \frac{2 {H}_{1}}{{Λ}_{{11}^{′}}} - \frac{{φ}_{{1}^{′}} - {φ}_{2}}{2 π} ) & ( 7 )\end{matrix}$$

When the difference between the frequency f′₁ of light from the variable frequency light source 201 and the frequency f₂ of light from the fixed frequency light source 202a is 0.3 THz, the synthetic wavelength Λ_{1′2} becomes 1.1 mm. Since the synthetic wavelength Λ_{1′2} is shorter than the synthetic wavelength Λ_{11′}, the optical path length difference H₂ calculated from equation (5) is more accurate than the optical path length difference H₁ calculated from equation (3). Assuming that the calculation accuracy of the optical path length difference is 1/200 of the synthetic wavelength Λ_{11′}, that of the optical path length difference H₁ becomes 0.15 mm, which is half or less of the synthetic wavelength Λ_{1′2}. Thus, the order M₂ of interference can be uniquely determined.

Then, the third beat signal of light from the fixed frequency light source 202b is analyzed. A phase φ₃ is calculated from the third beat signal by performing calculation such as the N bucket method or discrete Fourier transform for the respective pixels of interference images obtained at the interval between time t₀ and time t₃.

From the phases φ₂ and φ₃, an optical path length difference H₃ of each pixel is calculated according to equation (8):

$${H}_{3} = \frac{{Λ}_{23}}{2} ( {M}_{3} + \frac{{φ}_{2} - {φ}_{3}}{2 π} ) \qquad ( 8 )$$

where Λ₂₃ is the synthetic wavelength given by equation (9), and M₃ is the order of interference given by equation (10):

$$\begin{matrix}{Λ}_{23} = \frac{c}{\vert {f}_{2} - {f}_{3} \vert} & ( 9 ) \\ {M}_{3} = round ( \frac{2 {H}_{2}}{{Λ}_{{1}^{′} 2}} - \frac{{φ}_{2} - {φ}_{3}}{2 π} ) & ( 10 )\end{matrix}$$

When the difference between the frequency f₂ of light from the fixed frequency light source 202a and the frequency f₃ of light from the fixed frequency light source 202b is 6.4 THz, the synthetic wavelength Λ₂₃ becomes 47 μm. Since the synthetic wavelength Λ₂₃ is shorter than the synthetic wavelength Λ_{1′2}, the optical path length difference H₃ calculated from equation (8) is more accurate than the optical path length difference H₂ calculated from equation (5). Assuming that the calculation accuracy of the optical path length difference is 1/200 of the synthetic wavelength Λ_{1′2}, that of the optical path length difference H₂ becomes 5.5 μm, which is half or less of the synthetic wavelength Λ₂₃. Thus, the order M₃ of interference can be uniquely determined.

A higher-accuracy optical path length difference H₄ is calculated according to equation (11) using the frequency f₂ of light from the fixed frequency light source 202a:

H₄=c₂/2f₂(M₄+φ₂/2π) (11)

where M₄ is the order of interference given by equation (12):

$${M}_{4} = round ( \frac{2 {H}_{3}}{{Λ}_{23}} - \frac{{φ}_{2}}{2 π} ) \qquad ( 12 )$$

When a wavelength c/f₂ of light from the fixed frequency light source 202a is 780 nm, it is shorter than the synthetic wavelength Λ₂₃. Thus, the optical path length difference H₄ calculated from equation (11) is higher in accuracy than the optical path length difference H₃ calculated from equation (8). Assuming that the calculation accuracy of the optical path length difference is 1/200 of the synthetic wavelength Λ₂₃, that of the optical path length difference H₃ becomes 340 nm, which is half or less of the wavelength of 780 nm. Therefore, the order M₄ of interference can be uniquely determined.

By analyzing a plurality of beat signals and sequentially determining the order of interference in this fashion, the shape of the test object 170 can be measured in a wide range at high accuracy.

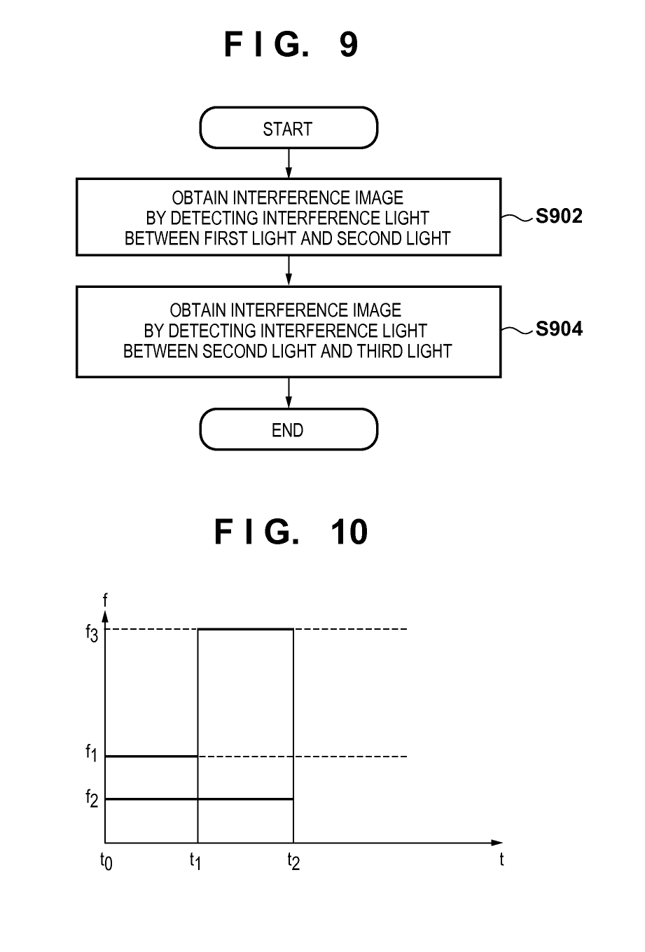

FIG. 9 is a flowchart for explaining in detail processing of obtaining a plurality of interference images in the actual measurement mode, that is, processing corresponding to step S504 in the measurement apparatus 20. Referring to FIG. 9, in step S902, the detection unit 140 detects interference light between the first light and the second light, obtaining an interference image. More specifically, as shown in FIG. 10, the detection starts from time t₀. The beat signals of the first light and second light are obtained till time t₁ while the frequency shifters 211a and 211b shift the frequencies. FIG. 10 is a graph showing a temporal change of the frequency of light from each of the variable frequency light source 201 and fixed frequency light sources 202a and 202b. In FIG. 10, the ordinate represents the frequency f, and the abscissa represents the time t.

In step S904, the detection unit 140 detects interference light between the second light and the third light, obtaining an interference image. More specifically, as shown in FIG. 10, the detection unit 140 obtains the beat signals of the second light and third light while the frequency shifters 211b and 211c shift the frequencies at the interval between time t₁ and time t₂.

Assuming that the number of interference images obtained in each of the processes in steps S902 and S904 is, for example, 17, a total of 34 interference images are obtained. Assuming that the image sensing rate of an interference image obtained by the detection unit 140 is 60 fps, the time taken to obtain an interference image is 0.57 sec. In the actual measurement mode, the number of interference images obtained by the detection unit 140 is half the number of interference images in the registration mode, so the time taken to measure the shape of the test object 170 can be shortened greatly.

When the frequency difference between the frequency f₁ of light from the variable frequency light source 201 and the frequency f₂ of light from the fixed frequency light source 202a is 0.3 THz, the synthetic wavelength Λ₁₂ becomes 1.1 mm. When the shape of the test object 170 having a height equal to or larger than the synthetic wavelength Λ₁₂ is measured, no order of interference can be determined, and the height of the test object 170 becomes uncertain.

In the embodiment, to eliminate this uncertainty, shape data (shape data representing the shape of the test object 170 that has been measured in the registration mode) stored in the storage unit 180 in the registration mode is used. By collation with shape data stored in the storage unit 180, the order of interference can be determined to calculate the optical path length difference.

As described above, the measurement apparatus 20 according to the second embodiment can easily measure the shape of the test object 170 in a short time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-243851 filed on Nov. 5, 2012, which is hereby incorporated by reference herein in its entirety.

What is claimed is:

1. A measurement apparatus which measures a shape of a test object, comprising:
a detection unit configured to detect interference light between reference light from a reference surface and test light from the test object, thereby obtaining an interference image; and
a processing unit configured to perform processing of obtaining the shape of the test object based on the interference image obtained by the detection unit,
wherein in a first measurement mode in which the interference image is obtained under a measurement condition that an optical path length difference measurable range where an optical path length difference does not become uncertain and can be measured is a first range, the processing unit obtains a first shape of the test object based on the interference image obtained by the detection unit in the first measurement mode, and
in a second measurement mode in which the interference image is obtained under a measurement condition that the optical path length difference measurable range is a second range smaller than the first range, the processing unit obtains a second shape of the test object by using data of the obtained first shape, and the interference image obtained by the detection unit in the second measurement mode.

2. The apparatus according to claim 1, further comprising a storage unit configured to store shape data representing the shape of the test object that is calculated based on the interference image obtained by the detection unit,
wherein in the first measurement mode, the first shape data is stored in the storage unit in association with a type of the test object, and
in the second measurement mode, the processing unit extracts, from the storage unit, shape data corresponding to a type of a test object to be measured in the second measurement mode, and obtains the second shape of the test object by using the extracted shape data, and the interference image obtained by the detection unit in the second measurement mode.

3. The apparatus according to claim 1, wherein the processing unit determines, by using the first shape data, an order of interference of interference light of the interference image obtained by the detection unit in the second measurement mode.

4. The apparatus according to claim 1, wherein
the processing unit obtains the second shape of the test object based on changes of a plurality of interference images obtained by the detection unit while a frequency of light to enter the reference surface and the test object is scanned at a predetermined scan interval, and
a scan interval of the frequency of the light in the first measurement mode is smaller than a scan interval of the frequency of the light in the second measurement mode.

5. The apparatus according to claim 4, wherein the processing unit sets the scan interval of the frequency of the light in the second measurement mode by using the first shape data to exclude a region where a frequency of the interference light becomes 0 or a Nyquist frequency.

6. The apparatus according to claim 4, wherein the number of synthetic wavelengths used in the first measurement mode is larger than the number of synthetic wavelengths used in the second measurement mode.

7. The apparatus according to claim 1, further comprising an interference optical system configured to form interference light between the reference light and the test light,
wherein in the second measurement mode, the processing unit adjusts a positional relationship between the interference optical system and the test object to improve a contrast of the interference image obtained by the detection unit by using the first shape data.

8. The apparatus according to claim 1, further comprising a selection unit configured to select one measurement mode from measurement modes including the first measurement mode and the second measurement mode.

9. A measurement method of detecting interference light between reference light from a reference surface and test light from a test object to obtain an interference image, and measuring a shape of the test object based on the obtained interference image, comprising the steps of:
in a first measurement mode in which the interference image is obtained under a measurement condition that an optical path length difference measurable range where an optical path length difference does not become uncertain and can be measured is a first range, obtaining a first shape of the test object based on the interference image obtained in the first measurement mode; and
in a second measurement mode in which the interference image is obtained under a measurement condition that the optical path length difference measurable range is a second range smaller than the first range, obtaining a second shape of the test object by using data of the obtained first shape and the interference image obtained in the second measurement mode.
